(19) United States
(12) Patent Application Publication
(10) Pub. No.: US 2010/0129710 A1
(43) Pub. Date: May 27, 2010

(54) LITHOGRAPHICALLY PRINTED CELLS

(75) Inventors: Darren John Southee, Middlesex (GB); Gareth Ian Hay, Middlesex (GB); Peter Sidney Albert Evans, Middlesex (GB); David Harrison, Middlesex (GB)

Correspondence Address: DARBY & DARBY P.C., P.O. BOX 770, Church Street Station, New York, NY, 10008-0770, US

(73) Assignee: Brunel University, Middlesex (GB)

(21) Appl. No.: 12/301,924

(22) PCT Filed: May 23, 2007
(86) PCT No.: PCT/GB2007/001915

§ 371 Date: Feb. 13, 2009

(30) Foreign Application Priority Data
May 23, 2006 (GB) 0610237.0

(51) Int. Cl. H01M 4/36; B05D 5/12

(52) U.S. Cl. 429/209; 427/77; 252/182.1

(57) ABSTRACT

There are disclosed cells (100, 200, 300, 444) which include one or more layers formed by a lithographic printing process. The layers may be formed by offset lithographic printing. In one embodiment, a cathode substrate (110) is coated with a silver current collector layer (115) and a graphite layer (120). A paste (170) of manganese (IV) oxide and carbon is deposited over the graphite layer (120). A membrane (180) separates the anode and cathode. An anode substrate (140) is coated with a silver current collector layer (145) and a zinc layer (150). The lithographic inks include a resin to provide thixotropic properties. The cells (100, 200, 300, 444) can be manufactured more rapidly than by screen printing, while using less ink than screen printing.

This invention is concerned with the manufacture of voltaic cells, i.e. electrochemical cells (sometimes also known as batteries), by lithographic printing. The invention is particularly, but not exclusively, concerned with the manufacture of cells by the offset lithographic printing process.

WO 97/22466 discloses an “open” electrochemical cell. The cell is open in the sense that the electrolyte is not sealed with the cell; this avoids the problem of accumulation of gases within the cell during storage. The cell has a deliquescent electrolyte, to absorb moisture from the atmosphere, so that the electrolyte does not dry out. WO 97/22466 is primarily concerned with screen printing of the electrochemical cell.

The present inventors have realised that lithographic printing potentially offers a number of advantages over screen printing, including: more rapid manufacture and reduced cost of the materials in a printed electrochemical cell.

The inventors have also realised that inks that are suitable for screen printing are not suitable for lithographic printing. The inventors have devised thixotropic ink formulations that allow lithographic printing of electrochemical cells.

Lithographic printing is a printing process in which a printing plate, which may be in the form of a roller, has hydrophilic and hydrophobic (oily) regions. Ink is repelled by the hydrophilic region(s) and adheres only to the hydrophobic region(s).

The term “lithographic printing” referred to herein is a printing process which utilizes differences in surface chemistry of the printing plate, including hydrophilic and hydrophobic properties. It does not refer to the commonly used process involving photoresist and etching occurring during the production of etched circuits boards and/or silicon semiconductor micro electronics. The term “ink” is intended to mean any material suitable for printing.

Lithographic printing is often performed in an “offset” manner; instead of the printing plate being used to directly print onto a media substrate, the printing plate prints onto an “offset” roller. The offset roller is then used to transfer the printed image onto the media substrate.

According to another aspect of the present invention, there is provided a method of making an electrochemical cell, comprising the step of:
lithographically printing a layer of an electrochemical cell.

According to another aspect of the present invention, there is provided an electrochemical cell comprising:
a substrate;
an anode;
a cathode;
an electrolyte,
wherein at least one of the anode and cathode is lithographically printed.

According to one aspect of the present invention, there is provided a thixotropic ink comprising:
an anode or a cathode powder; and
a resin.

According to another aspect of the present invention, there is provided a method of making an electrochemical cell, comprising the steps of:
printing an anode layer onto a membrane or substrate;
printing a cathode layer onto the membrane or substrate; and
folding the membrane or substrate.

### DESCRIPTION OF DRAWINGS

FIG. 1a shows an exploded view of a layer stack of a printed cell having a zinc anode, a cathode in the form of a paste comprising carbon and manganese (IV) oxide, a graphite layer, and two silver current collectors.

FIG. 1b shows a side-on view of the layers of FIG. 1a.

FIG. 2a shows an exploded view of a layer stack of a printed cell that is similar to the printed cell of FIG. 1 but without the graphite layer, and in which the carbon and manganese (IV) oxide are deposited as an ink instead of as a paste.

FIG. 2b shows a side-on view of the layers of FIG. 2b.

FIG. 3 shows an exploded view of a layer stack of a printed cell having a zinc anode and a carbon cathode but without the silver current collectors of FIGS. 1 and 2.

FIG. 4a shows a membrane on which, on the same side of the membrane, an anode layer and a cathode layer have been printed.

FIG. 4b shows the membrane of FIG. 4a after the membrane has been folded to form a cell.

### DESCRIPTION OF PREFERRED EMBODIMENTS

### First Embodiment

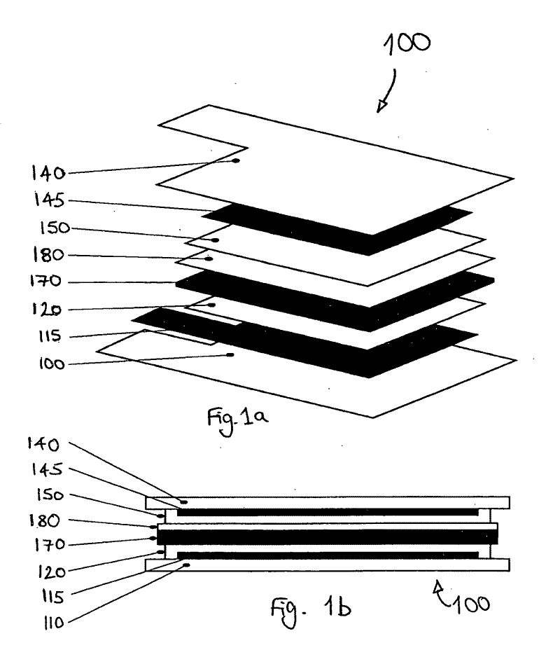

FIG. 1a shows an exploded view of a layer stack of a cell 100. The cell 100 has a cathode substrate 110 and an anode substrate 140.

A silver loaded conductive ink is lithographically printed onto the cathode substrate 110 to from a silver layer 115. Suitable compositions of the silver loaded conductive ink are described in WO 97/48257.

A graphite layer 120 is then lithographically printed onto the silver layer 115. In this embodiment, the composition of the graphite ink is:
XV1578 alkyd resin (from Lawter International, Kenosha, Wis., USA) 52.36% (weight/weight)
EXX-PRINT® M71a aliphatic and aromatic hydrocarbon diluent (from Exxon Corporation, Houston, Tex., USA) 14.96% (w/w)
Eugenol (an allyl chain-substituted guaiacol to delay oxidation of the alkyd resin to stop the ink drying on press) 0.68% (w/w)
KS6 graphite powder (from Gwent Electronic Material, Pontypool, UK) 32% (w/w)

A silver loaded conductive ink is lithographically printed onto the anode substrate 140 to form a silver layer 145. The resin provides the graphite ink with thixotropic properties; the M71a diluent modifies the viscosity of the graphite ink by diluting the resin.

A zinc layer 150 is then lithographically printed onto the silver layer 145. In this embodiment, the composition of the zinc ink is:
XV1578 15% (w/w)
M71a 4.8% (w/w)
Eugenol 0.2% (w/w)
ZN006020 zinc powder (from Goodfellow Cambridge Ltd, Huntingdon, UK) 80% (w/w)

Note that the before the zinc powder is incorporated into the zinc ink, the zinc powder is coated with 5.66% (w/w) heptanoic acid. The mean particulate size of the zinc powder and of the graphite powder (that make up the zinc ink and the graphite ink, respectively) is 3 μm.

The thickness of each of the layers 115, 120, 145, 150 is approximately 5 μm.

A cathodic paste 170 of a thickness of 300 μm is then stenciled over the graphite layer 120. In this embodiment the cathodic paste 170 has the following composition: MnO₂ 42.9%, carbon 14.2% and water 42.9%.

The membrane 180 is, in this embodiment, paper that is saturated with ammonium chloride solution (NH₄Cl 25%, water 75%).

The silver layers 115, 145 have a sheet resistivity of about 10 Ω/m² and act as current collectors to reduce the internal resistance of the cell 100. The cell 100 has a terminal potential in the region of 1.5V.

To be lithographically printable, it is important that an ink is hydrophobic and is thixotropic (i.e. has non-Newtonian properties).

In this embodiment, the ink fabrication process includes the following steps:
polymeric ink vehicle mixed;
conductive particulate introduced;
three roll milling;
fineness of grind dispersion tested; and
assessment of rheological properties.

The polymer-based vehicle portion of the ink consists of three components: (i) a polymeric resin, which constitutes the largest portion of the vehicle, (ii) an optional non-volatile dilutant to adjust the viscosity and (iii) an optional anti-oxidant agent to retard drying of the ink during printing.

Each component of the ink is combined and agitated until a smooth uniform mixture is formed. To improve distribution of particulates and break down agglomerates, the mixture is sheared on a three-roll mill. Without the process of milling it is likely that agglomerates of active material will exist, thus reducing the likelihood of the ink attaining the correct rheological properties while also introducing uncertainties to the electrical characteristics of the cured ink film. Breaking down of the agglomerates causes an increase in particulate surface area which, in turn, leads to a larger spread of vehicle over the surface of the active material, causing an increase in viscosity.

Ink rheological characteristics may be measured using a cone and plate type viscometer, such as model Haake VT550. It is important that lithographic printing inks attain the property of thixotropy (shear thinning).

Ink specimens are subjected to shear rates from 0 to 400 s⁻¹. During testing, measurements of shear stress are recorded and used to calculate the viscosity by the rule:

η=τ/γ

where η denotes viscosity (Pascal second, Pas), τ denotes shear stress (Pa) and γ denotes shear rate (s⁻¹). Ink running through the ink train of a lithographic printing press is likely to be subjected to shear rates in the region of 10,000 s⁻¹. However, in test conditions these shear rates are difficult to reproduce. It is widely accepted that if an ink achieves a viscosity in the region of 7-12 Pas at 400 s⁻¹, while exhibiting thixotropic behaviour, it is likely to perform well at increased shear rates.

The use of lithographic printing has several advantages over screen printing. The layer thickness of a lithographically printed layer is typically about 5 μm, compared to about 50 μm for screen printing. Thus a reduced quantity of ink is used, compared to screen printing, to coat a given area of substrate. Also, lithographic printing is capable of higher speed and higher resolution than screen printing.

### Second Embodiment

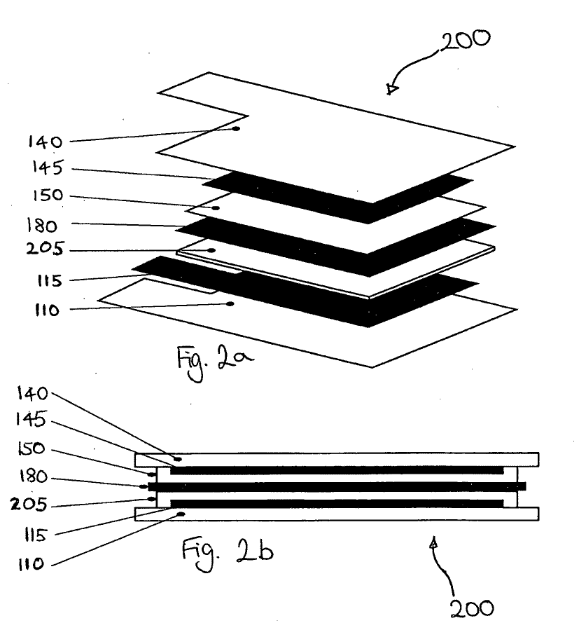

FIG. 2 shows a cell 200 similar to the cell 100 except that the cell 200 does not have a graphite layer 120 or a manganese (IV) oxide-carbon paste layer 170.

Instead, the cell 200 has a cathode layer 205 comprising manganese (IV) oxide and carbon. The cathode layer 205 is lithographically printed onto the silver layer 115.

The membrane 180 is a permeable membrane that acts as an electrode separator and contains saturated ammonium chloride solution.

### Third Embodiment

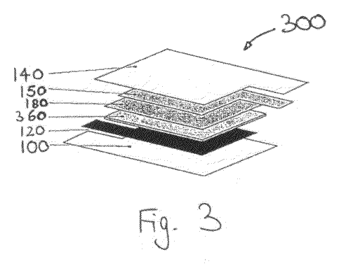

FIG. 3 shows an exploded view of a layer stack of a printed cell 300 having a zinc anode and a carbon cathode but without the silver current collectors 115, 145 of FIGS. 1 and 2.

The cell 300 has an electrolyte layer 360 between the carbon layer 120 and the membrane 180.

The electrolyte layer 360 is formed by dispersing a small quantity of polyethylene oxide in water followed by the introduction of ammonium chloride. A small quantity of manganese dioxide, in fine particulate form, is introduced to the formulation to act as a depolarising element.

The principal operation of the membrane separator 180 is to contain the electrolyte, thus preventing migration of this phase through the cell 300.

The cells 300 is sealed using adhesive treated polymer film (not shown).

Discharge testing of the cell 300 has showed that an output greater than 1 volt was achievable. However, the current capability of the cell 300 was relatively poor compared to the cells 100, 200 (which included current collector layers 115, 145). It is considered that the reduced current capability is due to the relatively high sheet resistance of the graphite layer 120 and the zinc layer 150 (approximately 1.5 kΩ/m² and 2 MΩ/m², respectively).

In alternative embodiments, two or more layers of the graphite layer 120 and/or two or more layers of the zinc layer 150 are printed, in order to reduce the internal resistance of the cell 300.

In alternative embodiments, the cell 300 is not sealed. In one embodiment, a deliquescent electrolyte is used and the cell 300 is open.

### Fourth Embodiment

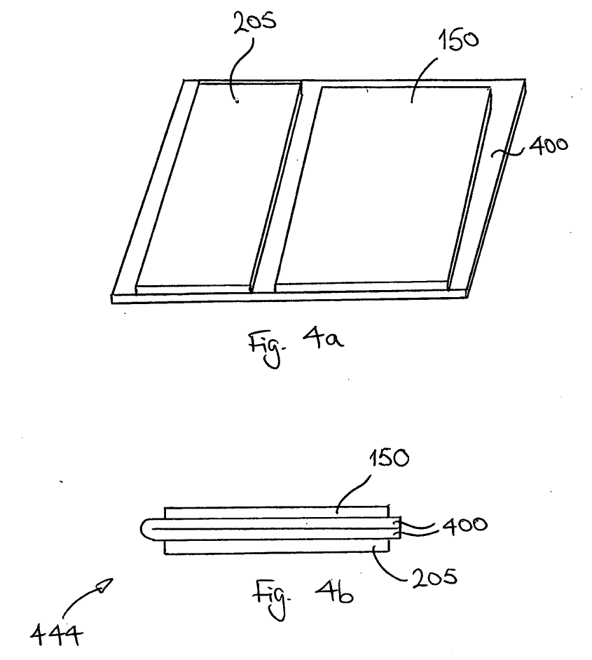

FIG. 4a shows a membrane 400 on which, on the same side of the membrane, an MnO₂-carbon cathode layer 205 and a zinc anode layer 150 have been printed.

FIG. 4b shows the membrane 400 of FIG. 4a after the membrane 400 has been folded to form a cell 444. In this embodiment the MnO₂-carbon cathode layer 205 and the zinc anode layer 150 are symmetrically arranged on the membrane 400 to produce the layer stack shown at FIG. 4b.

The membrane 400 may be fixed to a substrate for increased rigidity. An electrolyte solution may then be introduced into the membrane 400. The membrane 400 may then be encapsulated in order to prevent evapouration of the electrolyte.

In alternative embodiments, the cathode layer 205 and the anode layer 150 may be provided with current collectors, for example a silver layer 115 (not shown) and a silver layer 145 (not shown), respectively.

In other embodiments, the membrane 400 is replaced with a substrate. A cathode layer 205 and an anode layer 150 are printed at different regions on the same side of the substrate. The substrate is then folded and a membrane 180 is interposed between the cathode layer 205 and the anode layer 150, to form an electrochemical cell.

In yet other embodiments, instead of being lithographically printed on the same side of the membrane 400, the cathode layer 205 is lithographically printed on the bottom side of the membrane 400 and the anode layer 150 is lithographically printed at a corresponding position on the top side of the membrane 400. In this embodiment, there is no need to fold the membrane 400.

### Further Embodiments

Embodiments described above were based on zinc-carbon (similar to Leclanché) cells. In alternative embodiments, alkaline type cells may be made by using potassium hydroxide as the electrolyte instead of ammonium chloride or zinc chloride. In yet other embodiments, cells may be based on a zinc anode and a silver oxide cathode.

In embodiments described above, each lithographically printed layer had a thickness of about 5 μm. In some circumstances, it may be desirable to increase the thickness of one or more of the printed layers. For example, the thickness of the zinc anode may be increased (increasing the thickness of the zinc anode will tend to increase the shelf life of the cell; zinc has a tendency to react with the electrolyte to form hydrogen, thereby depleting the quantity of zinc remaining for electrochemistry). This may be achieved by printing two or more layers 150 on top of each other. A first zinc anode layer 150 may be allowed to dry before a second zinc anode layer 150 is printed on top of the first zinc anode layer 150.

In embodiments described above, the current collector layers 115, 145 were formed of silver. In alternative embodiments, some other conductor may be used. For example, gold may be used instead of silver.

In embodiments described above, the majority of the layers of the cell were printed by lithography. In alternative embodiments, one or more of the layers is printed lithographically. The other layers may be, for example, printed by screen printing or may be formed by some other process that does not involve printing.

Embodiments described above had two substrates, an anode substrate 140 and a cathode substrate 110. In alternative embodiments, the layers may be printed and/or formed onto a single substrate.

Embodiments described above mentioned the use of paper as an example of the membrane. In alternative embodiments, an ionic polymer such as Nafion® may be used.

In some embodiments, zinc metal powder and graphite powder are rendered printable via the offset lithographic printing process by incorporation into organic resin and hydrocarbon fraction vehicles containing rheology modifiers and anti-oxidants. The resulting lithographic printing inks are deposited by an offset-lithographic printing press to form electrode structures for one or more voltaic cells. A depolarising layer formed from manganese dioxide—either in suspension, or deposited as a further lithographic ink layer is overprinted onto one or both structures. The structures can be deposited onto various paper and paper-like substrate materials via the offset lithographic printing process. These structures, in combination with electrolyte solutions form voltaic sources that enable the production of lithographically printed electronic circuits and systems with integrated power supplies.

In one embodiment, the cathode ink comprises:
Graphite powder particulate possessing a mean particulate size of 3.4 micrometers: 32% by weight.
Hydrocarbon resin containing a styrenated alkyd: 52.36% by weight.
High boiling point petroleum solvent fraction with about 24% aromatic content: 14.96% by weight.
Antioxidant: 0.68% by weight.

In one embodiment, the anode ink comprises:
Zinc powder particulate possessing a mean particulate size of 3 micrometers: 75% by weight.
Hydrocarbon resin containing a styrenated alkyd: 22.5% by weight.
High boiling point petroleum solvent fraction with about 24% aromatic content: 2.25% by weight.
Antioxidant: 0.25% by weight.

The abstract of the present application and the disclosures of GB 0610237.0, from which the present application claims priority, are hereby incorporated by reference.

1. A method of making an electrochemical cell comprising the step of:
lithographically printing one or more layers of the electrochemical cell.

2. The method according to claim 1, wherein the one or more layers are lithographically printed onto a substrate.

3. The method according to claim 1, wherein the one or more layers are lithographically printed onto a membrane.

4. The method according to claim 1, wherein the step of lithographically printing the layer comprises offset lithographic printing.

5. The method according to claim 1, comprising at least one of the following steps:
lithographically printing an anode current collector layer;
lithographically printing an anode layer;
lithographically printing a cathode layer; and
lithographically printing a cathode current collector layer.

6. The method according to claim 5, wherein the anode layer comprises zinc.

7. The method according to claim 5, wherein the cathode layer comprises at least one of graphite and manganese (IV) oxide

8. The method according to claim 5, wherein at least one of the anode current collector layer, anode layer, cathode layer and cathode current collector layer comprises a plurality of layers.

9. The method according to claim 8, wherein each of the plurality of layers is formed by lithographic printing.

10. The method according to claim 1, wherein at least one layer of the cell is screen printed.

11. The method according to claim 10, wherein the at least one layer comprises a cathodic paste layer comprising graphite and manganese (IV) oxide.

12. The method according to claim 2, comprising the step of folding the substrate.

13. An electrochemical cell comprising:
at least one of an anode layer and a cathode layer, wherein the at least one layer comprises a thixotropic resin.

14. The electrochemical cell according to claim 13, comprising at least one of an anode current collector layer and a cathode current collector layer.

15. An ink for lithographically printing the anode or cathode of an electrochemical cell, comprising:
one of an anode or cathode powder;
a rheologically non-Newtonian resin.

16. The ink according to claim 15, wherein the ink is for printing an anode, and wherein the powder comprises zinc.

17. The ink according to claim 15, wherein the ink is for printing a cathode, and wherein the powder comprises at least one of graphite and manganese (IV) oxide.

18. The ink according to claim 15, comprising a hydrocarbon diluent.

19. The ink according to claim 15, comprising an anti-oxidant.

20. The method according to claim 3 comprising the step of folding the membrane.
